(19) United States
(12) Patent Application Publication
(10) Pub. No.: US 2020/0367017 A1
(43) Pub. Date: Nov. 19, 2020

(54) VIRTUAL AND REAL INFORMATION INTEGRATION SPATIAL POSITIONING SYSTEM

(71) Applicant: JORJIN TECHNOLOGIES INC., New Taipei City (TW)

(72) Inventors: Wen-Lung Liang, New Taipei City (TW); Wen-Hsiung Lin, New Taipei City (TW)

(21) Appl. No.: 16/409,886

(22) Filed: May 13, 2019

(51) Int. Cl. H04W 4/02; G06F 1/16; H04W 4/80

(52) U.S. Cl. CPC H04W 4/025; H04B 17/318; H04W 4/80; G06F 1/163

(57) ABSTRACT

A virtual and real information integration spatial positioning system includes an image output device, a processor unit, at least one network gateway, a plurality of mesh routers, a millimeter wave vibration detection module, a sound detection module, a wireless positioning module, and an image capturing module. The millimeter wave vibration detection module or the sound detection module or the wireless positioning module or the image capturing module is operable to acquire a signal feature value of a state of an article or an environment, which is transmitted through the mesh routers and the network gateway to the processor unit to generate positioning information of the article or the environment to be displayed on the image output device, to generate a simulation image that simulates the state of the article or the environment according to the signal feature value and a real image thereof.

### TECHNICAL FIELD OF THE INVENTION

The present invention relates generally to a spatial positioning system, and more particularly to a virtual and real information integration spatial positioning system.

### DESCRIPTION OF THE PRIOR ART

In the known positioning techniques, an example can be Bluetooth that is a wireless technology standard, can be used to realize short distance data exchange between fixed or mobile devices and a personal network of a specific space. Further, a device, such as iBeacon, that uses the Bluetooth functions, can be used in combination with a smart mobile device (such as a mobile phone) to realize indoor positioning with a user's mobile device. The positioning is such that detection of a distance between a signal point and a receiving point is measured by means of a received signal strength indication (RSSI) of the mobile phone, so that the mobile phone may determine the location. This is a technique of positioning that carries out positioning computation based on corresponding data.

In such a technical solution, the Bluetooth positioning system (such as iBeacon) can be used to monitor an article (such as a mobile) approaching or leaving away. When the mobile phone receives a Bluetooth broadcasting signal, the mobile phone may determine if the target (iBeacon) is approaching or leaving away from the mobile phone according to the variation of strength of the Bluetooth broadcasting signal, so that a message may be generated to signal a backstage monitor and control operator. However, such an iBeacon based Bluetooth positioning system does not provide an effective way of determining if the Bluetooth receiving terminal (the mobile phone) gets out of detection or accurate position thereof (for only the variation of the signal strength is applied for determination, but no spatial relation is involved), so that it is possible that positioning of the mobile phone holder may fail or become incorrect, leading to ineffective positioning. Such ineffective positioning does not tell where the person that is to be positioned is located, such as an accurate position thereof at a specific floor level or an accurate position thereof at different floor levels.

Further, in the known positioning system, no virtual and real positioning system is provided, exhibiting the capability of real time and learnable information transmission. For example, the previously mentioned Bluetooth positioning system provides a function of positioning, but does not provide information concerning the state of animate and inanimate objects or the environment in the environment or space where the person to be positioned is located in a real time manner, such as combined virtual and real information map data including sound (positioning) information, more accurate positioning, image positioning information. This is the technical drawback that the present invention aims to overcome.

### SUMMARY OF THE INVENTION

To achieve the above objective, the present invention provides a virtual and real information integration spatial positioning system, which comprises: an image output device; a processor unit, which communicates and connects with the image output device, the processor unit comprising a map data building module and an image postprocessing module, the processor unit communicating and connecting with a database; at least one network gateway, which communicates and connects, via a network, with the processor unit; a plurality of mesh routers, which communicate and connect with the network gateway; a millimeter wave vibration detection module, which comprises a first processor, a millimeter wave generator, a transmitting unit, and a receiving unit, the millimeter wave generator being electrically connected with the first processor, the transmitting unit and the receiving unit being each electrically connected with the millimeter wave generator, the first processor communicating and connecting with one of the mesh routers; a sound detection module, which comprises a sound issuing unit and/or a sound collecting unit and a second processor, the second processor comprising an analog-to-digital converter, the second processor being electrically connected with the sound issuing unit and/or the sound collecting unit, the second processor communicating and connecting with one of the mesh routers; a wireless positioning module, which comprises a third processor, the third processor communicating and connecting with one of the mesh routers; an image capturing module, which comprises an image capturing device and a fourth processor that are electrically connected with each other, the fourth processor communicating and connecting with one of the mesh routers.

Preferably, the image output device comprises one of a display screen, an optic projector, and a wearable smart device.

Preferably, the wireless positioning module comprises one of an iBeacon and a WiFi device.

Preferably, a portable smart device is further included and communicates and connects with one of the mesh routers.

Preferably, the database comprises a feature comparison module.

Preferably, one of the mesh routers is arranged as a mesh coordinator.

Thus, the millimeter wave vibration detection module or the sound detection module or the wireless positioning module or the image capturing module is operable to acquire a signal feature value of a state of an article or an environment, which is transmitted through each of the mesh routers and the network gateways to the processor unit to be processed by the processor unit to have the map data building module generate at least one. piece of positioning information regarding the state of the article or the environment to be displayed on the image output device, the image postprocessing module being operable to carry out post processing and generating a simulation image that simulates the state of the article or the environment according to the signal feature value and a real image of the state of the article or the environment to be displayed on the image output device so as to form integration of displaying of virtual and reality information and spatial positioning.

### BRIEF DESCRIPTION OF THE DRAWINGS

FIG. 1 is a block diagram of a preferred embodiment of the present invention.

FIG. 1A is a detailed block diagram of a millimeter wave vibration detection module of the preferred embodiment of the present invention shown in FIG. 1.

FIG. 1B is a detailed block diagram of a sound detection module of the preferred embodiment of the present invention shown in FIG. 1.

FIG. 1C is a detailed block diagram of a wireless positioning module of the preferred embodiment of the present invention shown in FIG. 1.

FIG. 1D is a detailed block diagram of an image capturing module of the preferred embodiment of the present invention shown in FIG. 1.

FIG. 2 is a schematic view illustrating the millimeter wave vibration detection module of the preferred embodiment of the present invention carrying out three-dimensional scanning and positioning on a state of each of articles or environment in a local environment or a specific space and predicting and generating positioning information of the state of each of the articles or environment, or the sound detection module carrying out sound issuing/collecting and positioning on a state of each of articles or environment in the local environment or specific space and predicting and generating positioning information of the state of each of the articles or environment, or the wireless positioning module being installed in a local environment or specific space and generating positioning information with respect to a communication device (such as a smart phone), or the image capturing module acquiring a state image of a state of each of articles or environment in a local environment or specific space for (real-time) monitoring and acquiring positioning information.

FIG. 3 is a block diagram illustrating one of mesh routers of the preferred embodiment of the present invention being arranged as a mesh coordinator.

### DETAILED DESCRIPTION OF THE PREFERRED EMBODIMENT

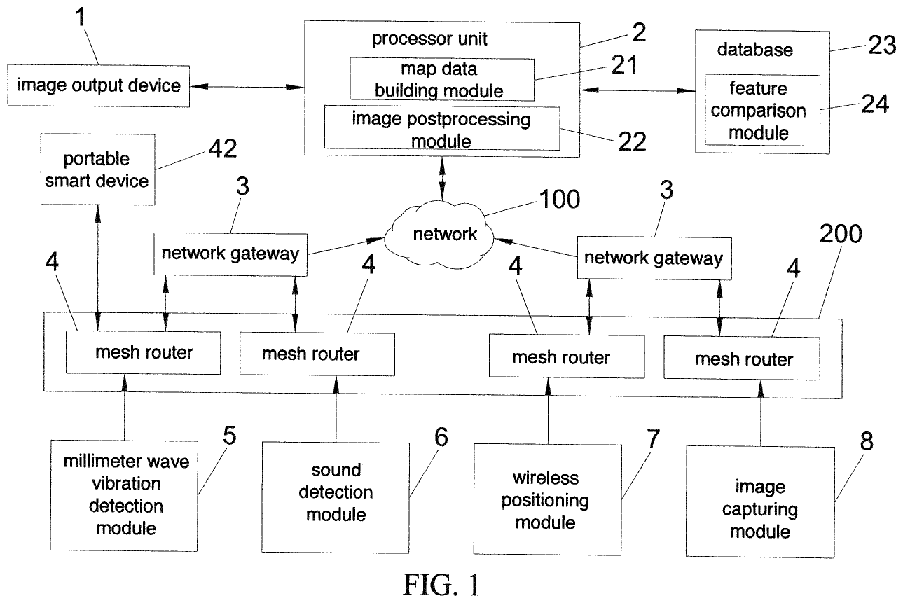

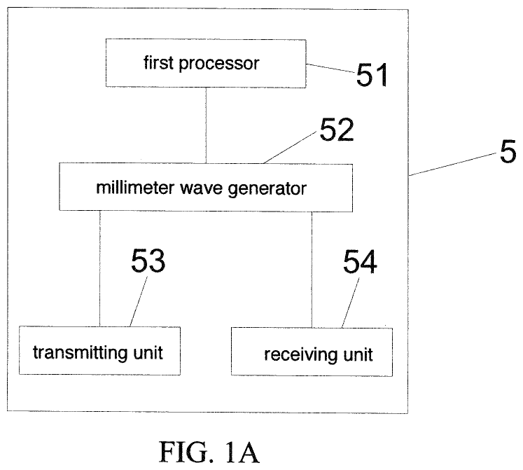

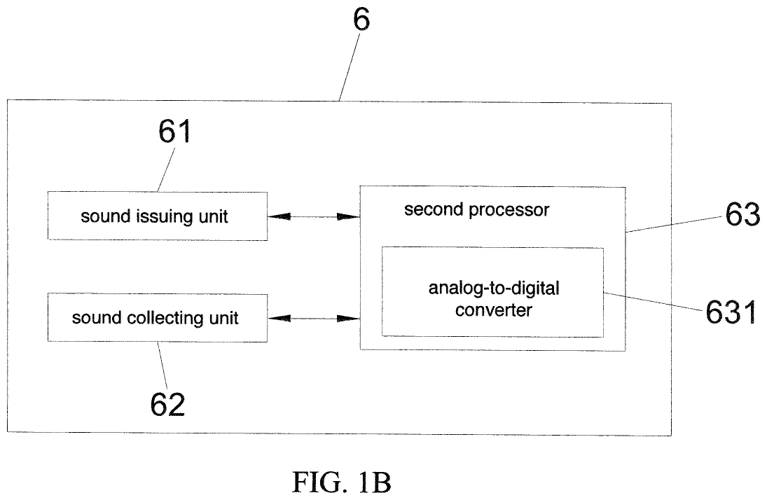

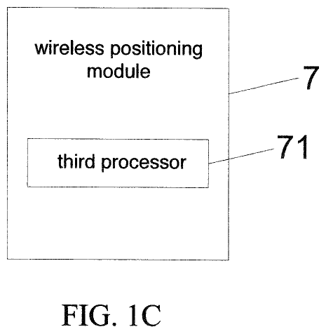

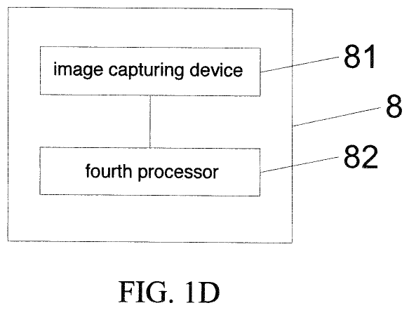

Referring to FIG. 1, the present invention provides a virtual and real information integration spatial positioning system, which comprises: an image output device 1, a processor unit 2, multiple network gateways 3, a plurality of mesh routers 4, a millimeter wave vibration detection module 5, a sound detection module 6, a wireless positioning module 7, and an image capturing module 8.

In the system, the processor unit 2 communicates and connects with the image output device 1. The image output device 1 can be a display screen or an optic projector or a wearable smart device, an is preferably a wearable smart device, such as a pair of intelligent spectacles. The processor unit 2 includes a map data building module 21 and an image postprocessing module 22. The processor unit 2 communicates and connects with a database 23. In the instant embodiment, the processor unit 2 can specifically be made up of an electronic device, and the electronic device can be such as a large-scale mainframe computer (PC), a notebook computer (NB), a smart phone, or other devices capable of processing signals. The map data building module 21 can specifically be a software application procedure (such as large-scale computer (PC) software or app), and can certainly be actually map fabrication software, but not limited thereto. Similarly, the image postprocessing module 22 can specifically be a software application procedure, and in addition, the database 23 includes a feature comparison module 24 for comparison and matching of data feature of the database 23.

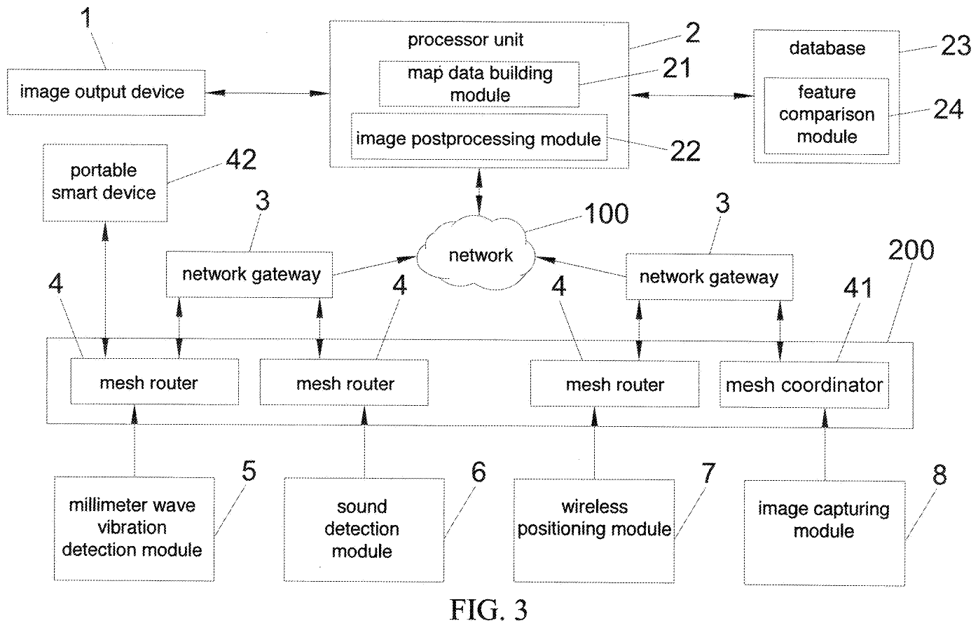

The multiple network gateways communicates and connects, through a network 100, with the processor unit 2. The mesh routers 4 make up a mesh network 200, communicates and connects, in a wireless or wired form, with each of the network gateways 3. The network gateways 3 are arranged so as not only to provide connection with a network (the Internet) but also to connect with the mesh network 200 for transmission of information. In the instant embodiment, referring to FIG. 3, one of the mesh routers 4 is arranged as a mesh coordinator 41 to proceed with network coordination.

Referring to FIG. 1A, the millimeter wave vibration detection module 5 includes a first processor 51, a millimeter wave generator 52, a transmitting unit 53, and a receiving unit 54. The millimeter wave generator 52 is electrically connected with the first processor 51, and the transmitting unit 53 and the receiving unit 54 are each electrically connected with the millimeter wave generator 52. The first processor 51 communicates and connects with one of the mesh routers 4.

Referring to FIG. 1B, the sound detection module 6 includes a sound issuing unit 61 and/or a sound collecting unit 62 and a second processor 63, the second processor 63 includes an analog-to-digital converter 631 for signal conversion. And, the second processor 63 is electrically connected with the sound issuing unit 61 and/or the sound collecting unit 62, and the second processor 63 communicates and connects with another one of the mesh routers 4.

Referring to FIGS. 1C and 1D, the wireless positioning module 7 includes a third processor 71. The third processor 71 communicates and connects with a further one of the mesh routers 4. The image capturing module 8 includes an image capturing device 81 and a fourth processor 82 that are electrically connected with each other. The fourth processor 82 communicates and connects with yet a further one of the mesh routers 4. As described above, in the instant embodiment, the mesh routers 4 are individually and respectively mountable to or carried on the millimeter wave vibration detection module 5, the sound detection module 6, the wireless positioning module 7, and the image capturing module 8 to directly build up the mesh network.

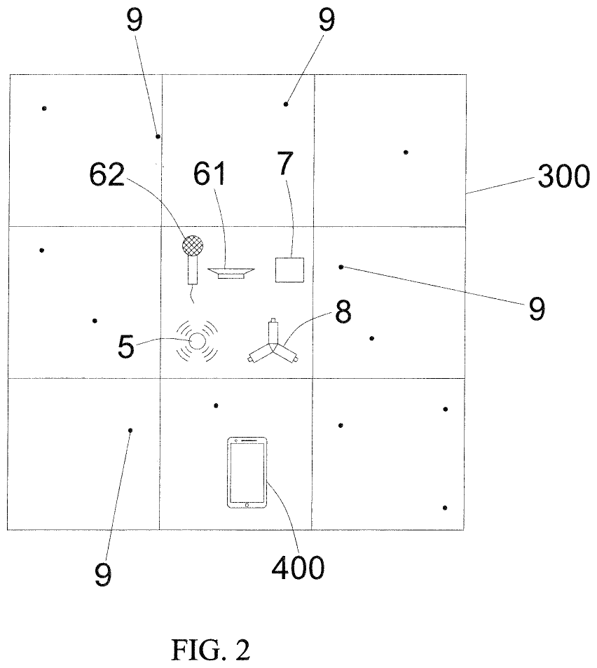

Thus, with further reference to FIGS. 1, 1A, and 2, a backstage design/monitor operator may first build up or install the millimeter wave vibration detection module 5 in a local environment or a specific space 300 so as to build up position information in original map data of the local environment or the specific space 300 according to the map data building module 21 to generate a (original) positioning point. Thus, by using or building up the millimeter wave vibration detection module 5 (such as being attached to an eave or a corner), the millimeter wave generator 52 may emit millimeter wave test signals multiple times at predetermined sampling frequencies to an article (which can be an obstacle or a moving source 9) and the environment of the local environment or specific space 300 by using the transmitting unit 53 and then receives, by using the receiving unit 54, a millimeter wave reflection signal formed by each of the millimeter wave test signals impinging and reflected by the article (the obstacle or the moving source 9 (vibration)) and environment. A ratio between the millimeter wave test signal and the millimeter wave reflection signal provides a signal feature value, so that the processor unit 2 may proceed with range finding according to radar principle (namely a distance between the millimeter wave vibration detection module 5 and (each) obstacle, (each) moving source 9, the environment (terrain)), and the map data building module 21 may calculate (in real-time) and generate at least one piece of positioning information for the article (obstacle or moving source 9) or environment. As such, positioning location among (each) obstacle, (each) moving source 9, and the environment can be calculated and combinable with the original map data.

Further, the image postprocessing module 22 may base on the signal feature value of the article (obstacle or moving source 9) and environment (terrain) and an real object image to proceed with post processing to generate a simulation image that accurately emulates the article (obstacle or moving source 9) and environment (terrain), so that images of the original map data and the (original) positioning point information of the millimeter wave vibration detection module 5 and the position information of mutual positioning among (each) obstacle, (each) moving source 9, and the environment and information of the simulation image are combined and overlapping each other and transmitted to the image output device 1 to be observed by the backstage monitor operator or user. In the instant embodiment, the article can be inanimate (an obstacle), such as a wall, a column, an eave, furniture, and other articles (containing metal) arranged in an indoor space, millimeter wave detection can be favorably applied, and can also be a lamp switch, a light fixture, a door cover, and a door panel. The article can also be animate (a moving source 9), such as a human and an animal (a self-carrying vibration source or heartbeat or vibrations caused by walking and moving).

Referring to FIG. 1, preferably, in addition to detection carried out by the millimeter wave vibration detection module 5 and processing carried out by the processor unit 2 to have the map data building module 21 generate the at least one. piece of positioning information of the article (obstacle or moving source 9) and environment, the data of the signal feature value can be stored in the database 23 for analysis and comparison and a next operation of the millimeter wave vibration detection module 5 (being built up or installed at a different location) detects and acquires a signal feature value, which is transmitted and stored in the database 23 for performance of feature matching by the feature comparison module 24 by comparing the first time stored signal feature value with the subsequently received signal feature value, in order to identify an article associated with each signal feature value, as being processed by the processor unit 2 and information being transmitted to the image output device 1 for information displaying for the corresponding map data, providing the map data built up with the map data building module 21 with capabilities of learning.

In the instant embodiment, in addition to what described above, referring to FIGS. 1, 1D, and 2, in the same local environment or specific space 300, at the (original) positioning point of installation of the millimeter wave vibration detection module 5, in the same positioning point, the image capturing module 8 is installed for use in combination with the millimeter wave vibration detection module 5. In the instant embodiment, the image capturing device 81 can be a multi-directional video camera, a camera, or an image sensor (CCD or CMOS device). Thus, the image capturing module 8 can capture (in real-time) an image signal of the article (obstacle or moving source 9) and environment (terrain), the image signal can be for example color analysis or optic analysis of images captured at multiple times from different angles and different directions for an obstacle or terrain, and position analysis and image analysis of images of a moving source 9 captured at multiple times after it has been moving, and are transmitted through each of the mesh routers 4 and each of the network gateways 3 to the processor unit 2, and processed by the processor unit 2 to have the map data building module 21 generate positioning (image) information of the article (obstacle or moving source 9) and environment that is overlapped on the original map data to be displayed on the image output device 1 for enhancing overall integration and correction of the map data.

Thus, the user may use the image output device 1 (such as a pair of intelligent spectacles) to directly, through operation options, watch the combined map data, (vibration) simulation image or video reality images (through operation option), of the article (obstacle or moving source 9) and environment in the local environment or specific space 300, and certainly, the user may use the intelligent spectacles to observer relative position relationship of a real image and the (vibration) simulation image of the article (obstacle or moving source 9) and environment and relative position relationship of map data of the article (obstacle) and the environment and the (vibration) simulation image of the moving source 9, so as to form displaying of virtual and real information and integration of spatial positioning.

Further, as shown in FIG. 1, in addition to displaying of information on the image output device 1 (such as an intelligent spectacles), the instant embodiment may further comprise a portable smart device 42, such as namely a smart phone, a notebook computer, a large-scale mainframe computer (PC), or intelligent spectacles, and particularly, when it is intelligent spectacles, it can directly communicate and connect with one of the mesh routers 4, and may similarly (real-time) acquire the same map data and image as those acquired by the image output device 1, without being constrained by distance (such as a portable smart device 42 and a user being abroad), to carry out sharing of remote monitoring.

Preferably, referring to FIGS. 1, 1B, 1C, and 2, in the same local environment or specific space 300, in addition to installation of the millimeter wave vibration detection module 5 and the image capturing module 8 in the (original) positioning point, it may further install, at the same (original) positioning point, a sound detection module 6 or a wireless positioning module 7 in the local environment or specific space 300. Thus, by means of a sound collecting unit 62 or a sound issuing unit 61 of the sound detection module 6, it may further (in real-time) acquire the positioning information (single direction) of the article (particularly a moving source 9 being a human or an animal) or the environment, or carry out sound notification, or in case of both the sound issuing unit 61 and the sound collecting unit 62 being included, sound can be issued and collected and more accurate positioning of the moving source 9 or environment can be made, and to be similarly transmitted through the mesh routers 4 and each of the network gateways 3 to the processor unit 2 to be processed by the processor unit 2 to have the map data building module 21 generate the positioning information of (real) sound of the moving source 9 or environment to be overlapped on the original map data, for displaying and transmitting to the image output device 1 (through operation options) for broadcasting, improving integration and accuracy of the entire map data.

And, further, referring to FIGS. 1, 1C, and 2, the wireless positioning module 7 can be built at the (original) positioning point of the map data of the same local environment or specific space 300. In the instant embodiment, the wireless positioning module 7 can be an iBeacon or a WiFi device, and in addition to a moving source 9, an article in the local environment or specific space 300 can also be a communication device 400 (such as a smart phone and intelligent spectacles). When a user holds the communication device 400 and enters the local environment or specific space 300 and operates or not operates a Beacon application service (a mobile application (App) corresponding thereto) of the communication device 400, thus, between the communication device 400 and the wireless positioning module 7, in addition to generating a specific ID (identity) for the wireless positioning module 7 to broadcast (push) with respect to the communication device 400, measurement can be further carried in regard to received signal strength indication (RSSI) of the communication device 400 to generate a signal feature value, which can be similarly transmitted through the mesh routers 4 and each of the network gateways 3 to the processor unit 2 to be processed by the processor unit 2 to have the map data building module 21 generate iBeacon map data for the positioning information of the communication device 400 to be overlapped on the original map data, so that all the previously described the map data can be used in combination to improve overall integration and accuracy of the map data.

Further, as shown in FIGS. 1 and 2, the embodiment of the present invention can be such that the millimeter wave vibration detection module 5, the sound detection module 6, the wireless positioning module 7 and the image capturing module 8 are mounted on an obstacle or a moving source 9 (such as a human or an animal) to form virtual and real information integration and spatial positioning.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A virtual and real information integration spatial positioning system, comprising:
an image output device;
a processor unit, which communicates and connects with the image output device, the processor unit comprising a map data building module and an image postprocessing module, the processor unit communicating and connecting with a database;
at least one network gateway, which communicates and connects, via a network, with the processor unit;
a plurality of mesh routers, which communicate and connect with the network gateway;
a millimeter wave vibration detection module, which comprises a first processor, a millimeter wave generator, a transmitting unit, and a receiving unit, the millimeter wave generator being electrically connected with the first processor, the transmitting unit and the receiving unit being each electrically connected with the millimeter wave generator, the first processor communicating and connecting with one of the mesh routers;
a sound detection module, which comprises a sound issuing unit and/or a sound collecting unit and a second processor, the second processor comprising an analog-to-digital converter, the second processor being electrically connected with the sound issuing unit and/or the sound collecting unit, the second processor communicating and connecting with one of the mesh routers;
a wireless positioning module, which comprises a third processor, the third processor communicating and connecting with one of the mesh routers; and
an image capturing module, which comprises an image capturing device and a fourth processor that are electrically connected with each other, the fourth processor communicating and connecting with one of the mesh routers, wherein the millimeter wave vibration detection module or the sound detection module or the wireless positioning module or the image capturing module is operable to acquire a signal feature value of a state of an article or an environment, which is transmitted through each of the mesh routers and the network gateway to the processor unit to be processed by the processor unit to have the map data building module generate at least one. piece of positioning information regarding the state of the article or the environment to be displayed on the image output device, the image postprocessing module being operable to carry out post processing and generating a simulation image that simulates the state of the article or the environment according to the signal feature value and a real image of the state of the article or the environment to be displayed on the image output device so as to form integration of displaying of virtual and reality information and spatial positioning.

2. The virtual and real information integration spatial positioning system according to claim 1, wherein the image output device comprises one of a display screen, an optic projector, and a wearable smart device.

3. The virtual and real information integration spatial positioning system according to claim 1, wherein the wireless positioning module comprises one of an iBeacon and a WiFi device.

4. The virtual and real information integration spatial positioning system according to claim 1 further comprising a portable smart device, which communicates and connects with one of the mesh routers.

5. The virtual and real information integration spatial positioning system according to claim 1, wherein the database comprises a feature comparison module.

6. The virtual and real information integration spatial positioning system according to claim 1, wherein one of the mesh routers is arranged as a mesh coordinator.
